(19) United States
(12) Patent Application Publication
(10) Pub. No.: US 2012/0298759 A1
(43) Pub. Date: Nov. 29, 2012

(54) STORAGE CARD ABLE TO RECEIVE CHIP CARD

(75) Inventor: CHIH-PIN CHEN, Tu-Cheng (TW)

(73) Assignee: HON HAI PRECISION INDUSTRY CO., LTD., Tu-Cheng (TW)

(21) Appl. No.: 13/195,031

(22) Filed: Aug. 1, 2011

(30) Foreign Application Priority Data
May 27, 2011 (TW) 100118564

(51) Int. Cl. G06K 19/077

(52) U.S. Cl. 235/492

(57) ABSTRACT

A storage card includes a lower cover, nine pins mounted on a bottom of the lower cover, a memory card mounted on the lower cover, a chip card connector mounted on the lower cover, and an upper cover engaged on the lower cover. The memory card is electrically connected to the nine pins. The chip card connector is electrically connected to six of the nine pins. The upper cover receives a chip card which comprises six contacts on its bottom. The upper cover defines an opening. The chip card connector is to pass through the opening to contact the six contacts of the chip card.

### BACKGROUND

1. Technical Field

The present disclosure relates to storage cards and, particularly, to a storage card for receiving a chip card, such as a SIM card.

2. Description of Related Art

Many electronic devices such as notebook computers define at least two slots, one of which is for receiving a storage card connector to read data from an external storage card, and another is for receiving a chip card connector to read data from an external chip card. However, having separate slots occupy too much space of the electronic device, making further miniaturization of the electronic device difficult.

### BRIEF DESCRIPTION OF THE DRAWINGS

FIG. 1 is an isometric view of a storage card for being inserted into an electronic device, in accordance with an exemplary embodiment.

FIG. 2 is an isometric view of the storage card of FIG. 1.

FIG. 3 is an isometric view of the storage card of FIG. 1, viewed from another aspect.

FIG. 4 is an exploded view of the storage card of FIG. 1.

FIG. 5 is an isometric view of a chip card to be received in the storage card of FIG. 1.

### DETAILED DESCRIPTION

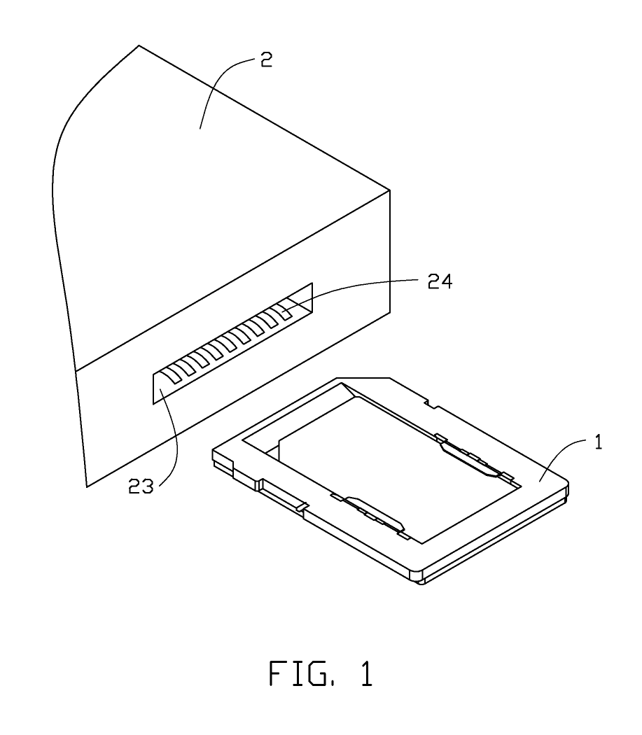

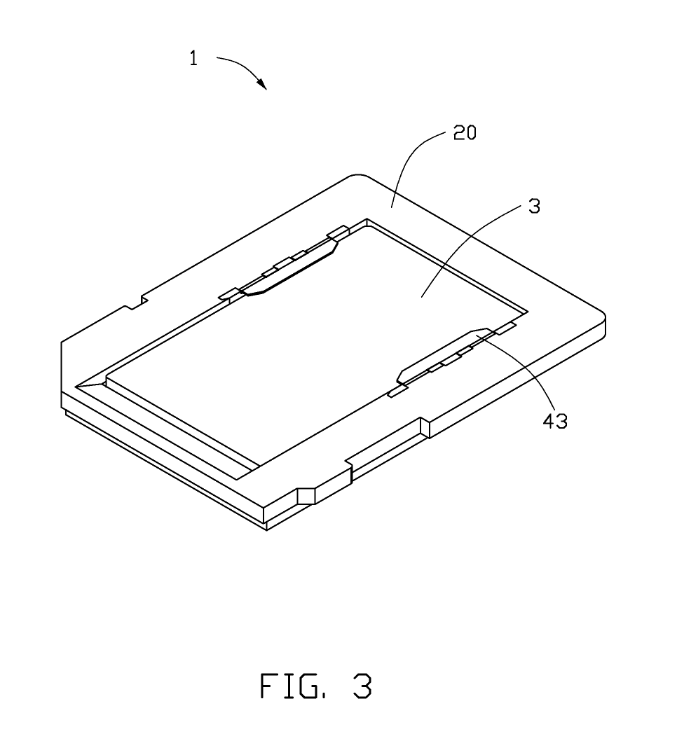

Referring to FIGS. 1-3, a storage card 1 is provided. The storage card 1 is used to be inserted into a storage card connector 24 of an electronic device 2. The storage card connector 24 is received in a slot 23 of the electronic device 2, and is controlled by the electronic device 2 to read data from the storage card 1. In one embodiment, the electronic device 2 is a notebook computer. In other embodiment, the electronic device 2 may be other devices, such as, electronic book, mobile phone, etc.

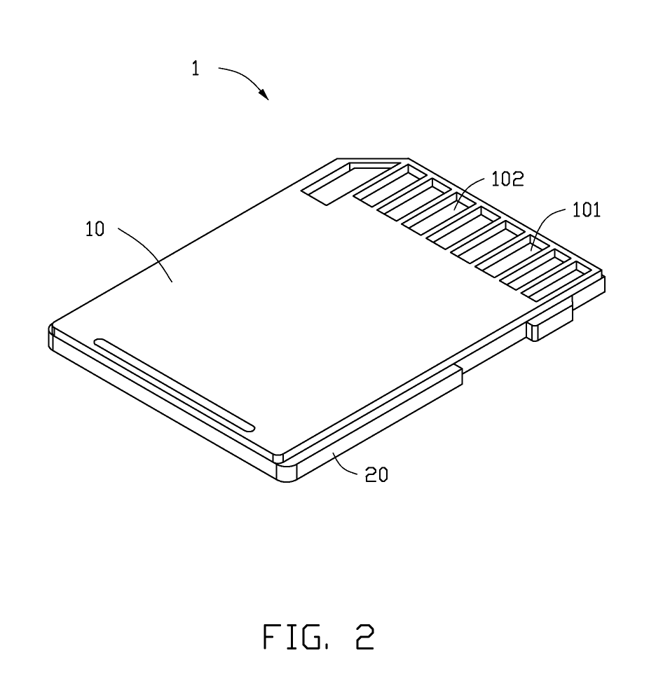

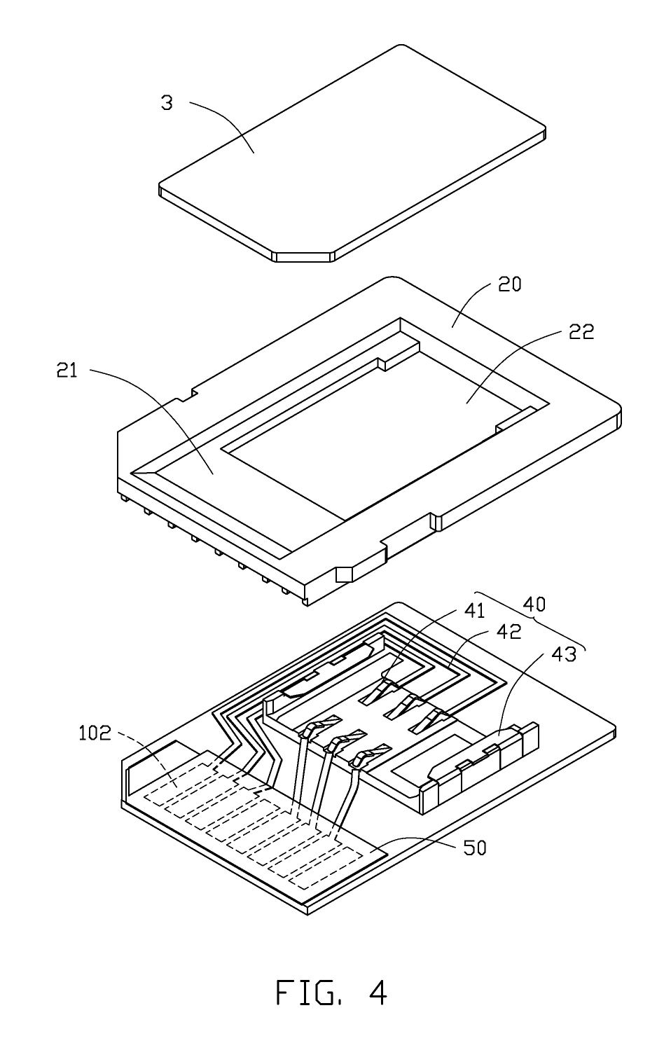

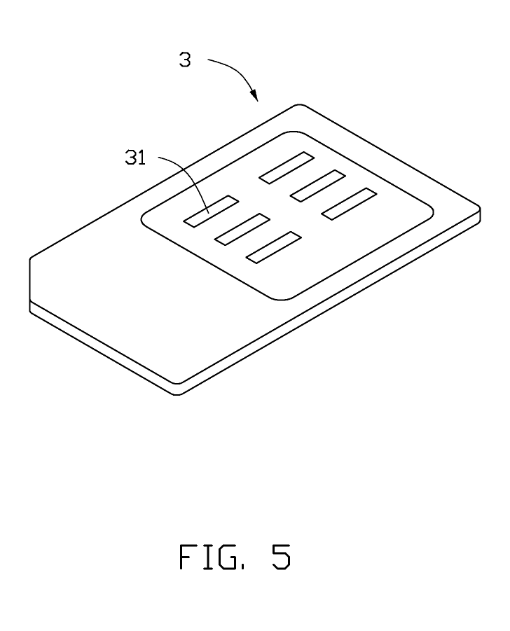

Referring to FIGS. 2-5, the storage card 1 includes a lower cover 10, nine pins 102 mounted on a bottom of the lower cover 10, a memory card 50 mounted on the lower cover 10 and electrically connected to the pins 102, a chip card connector 40 mounted on the lower cover 10 and electrically connected to six of the nine pins 102, and an upper cover 20 engaged on the lower cover 10. The upper cover 10 is configured to receive a chip card 3, and defines an opening 22. The chip card 3 includes six contacts 31 on its bottom. The chip card connector 40 passes through the opening 22 to contact the six contacts 31 of the chip card 3, and when the storage card 1 is inserted into the storage card connector 24 of the electronic device 2, the storage card connector 24 will be controlled by the electronic device 2 to read the data from the memory card 50 by the nine pins 102, or read the data from the chip card 3 by six of the nine pins 102. That is, the electronic device 2 can use the storage card connector 24 to read data from the memory card 50 or the chip card 3, so that only one slot need be defined, thereby reducing the size of the electronic device 2. In one embodiment, the chip card 3 is a SIM card, and the storage card 1 is a SD card. In order to better understand the disclosure, an exemplary embodiment is described in detail.

The lower cover 10 further defines nine slots 101 for receiving the nine pins 102. To read the data from the memory card 50, the device 2 controls the storage card connector 24 to communicate through the nine pins 102 to read the data from the memory card 50, and to read the data from the chip card 3, the storage card connector 24 is controlled to communicate through the six of the nine pins 102 to read the data from the chip card 3.

The upper cover 20 includes a recessed portion 21 in its top surface. The opening 22 is defined in a bottom of the recessed portion 21. The chip card 3 is received in the recessed portion 21.

The chip card connector 40 includes six contact portions 41, six transmission lines 42, and two hook portions 43 extending from two opposite sides thereof. The six contact portions 41 pass through the opening 22 to contact the six contacts 31 of the chip card 3 to read the data from the chip card 3. One end of each transmission line 41 is connected to one of the contact portions 41, and an opposite end is connected to one of the pins 102, thereby transmitting the data from the contact portions 41 to the six pins 102 respectively. The two hook portions 43 are exposed through the opening 22, and are configured to maintain the chip card 3 within the recessed portion 21.

To read the data from the chip card 3, the chip card 3 is inserted into the storage card 1, the storage card 1 is inserted into the storage card connector 24 of the electronic device 2, the storage card connector 24 is controlled by the electronic device 2 to read the data from the chip card 3 through six of the nine pins 102. To read the data from the storage card 1, the storage card connector 24 is controlled by the electronic device 2 to read the data from the memory card 50 through the nine pins 102.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A storage card comprising:
a lower cover;
nine pins mounted on a bottom of the lower cover;
a memory card mounted on the lower cover, and electrically connected to the nine pins;
a chip card connector mounted on the lower cover, and electrically connected to six of the nine pins; and
an upper cover engaged on the lower cover, and configured to receive a chip card which comprises six contacts on its bottom, wherein the upper cover defines an opening;
wherein the chip card connector is to pass through the opening to contact the six contacts of the chip card.

2. The storage card as described in claim 1, wherein the chip card is a SIM card, and the storage card is a SD card.

3. The storage card as described in claim 1, wherein the chip card connector comprises six contact portions, and six transmission lines, the six contact portions pass through the opening to contact the six contacts of the chip card to read the data from the chip card, one end of each transmission line is connected to one of the contact portions, and opposite end is connected to one of the pins, thereby transmitting the data from the contact portions to the six pins respectively.

4. The storage card as described in claim 1, wherein the lower cover defines nine slots for receiving the nine pins.

5. The storage card as described in claim 1, wherein the upper cover comprises a recessed portion in its surface, the opening is defined in a bottom of the recessed portion, the chip card is received in the recessed portion.

6. The storage card as described in claim 5, wherein the chip card connector further comprises two hook portions extending from two opposite sides thereof, the two hook portions are exposed through the opening, and are configured to maintain the chip card within the recessed portion.

7. A storage card comprising:
a lower cover;
a plurality of pins mounted on a bottom of the lower cover;
a memory card mounted on the lower cover, and electrically connected to the pins;
a chip card connector mounted on the lower cover, and electrically connected to a number of the pins; and
an upper cover engaged on the lower cover, and configured to receive a chip card which comprises a same number of contacts as the number of the pins electrically connected to the chip card connector, wherein the upper cover defines an opening;
wherein the chip card connector is to pass through the opening to contact the contacts of the chip card.
